(19) United States
(12) Patent Application Publication
(10) Pub. No.: US 2023/0315883 A1
(43) Pub. Date: Oct. 5, 2023

(54) METHOD TO PRIVATELY DETERMINE DATA INTERSECTION

(71) Applicant: International Business Machines Corporation, Armonk, NY (US)

(72) Inventors: Allon Adir, Kiryat Tivon (IL); Michael Mirkin, Tivon (IL); Omri Soceanu, Haifa (IL); Ramy Masalha, Kafr Qari (IL); Nir Drucker, Zichron Yaakov (IL); Eyal Kushnir, Kfar Vradim (IL)

(21) Appl. No.: 17/707,099

(22) Filed: Mar. 29, 2022

(51) Int. Cl. G06F 21/62; G06F 21/64

(52) U.S. Cl. CPC G06F 21/6218; G06F 21/64

(57) ABSTRACT

A computer-implemented method for privately determining data intersection is disclosed. The computer-implemented method includes performing private set intersection between two record sets to determine identical intersecting records corresponding to a particular record field. The computer-implemented method includes removing any identical intersecting records from each record set to form two record subsets. The computer-implemented method includes separately computing locality sensitive hash values for each of the two record subsets, wherein the locality sensitive hash values are computed for records corresponding to the particular record field. The computer-implemented method includes jointly performing private set intersection between the locality sensitive hash values separately computed for each of the two record subsets. The computer-implemented method further includes determining that an intersecting pair of records between the two record subsets are a match based, at least in part, on a similarity score associated with the intersecting pair of records being above a predetermined threshold.

### STATEMENT REGARDING PRIOR DISCLOSURES BY THE INVENTOR OR JOINT INVENTOR

The following disclosure is submitted under 35 U.S.C. 102(b)(1)(A):

The invention was publicly disclosed on Jul. 29, 2021. Further, AUTHORS DISCLOSED ANONYMOUSLY, “Privacy-preserving record linkage using local sensitive hash and private set intersection”, submitted Mar. 21, 2022 in preparation for Cloud S&P 2022, 4th Workshop on Cloud Security & Privacy to be held 20-23 Jun. 2022, Rome Italy.

### BACKGROUND

The present invention relates generally to the field of entity resolution, and more particularly to, private set intersection and local sensitivity hashing to preserve sensitive material while determining data intersection.

Entity resolution (ER) methods try to detect cases where the same entity is represented in different data records. For example, “deduplication” identifies duplicate pairs/sets of records within the same database, whereas “record-linkage” (RL)—the focus of this disclosure, identifies pairs/sets of records in two databases that refer to the same entity. ER must take into account that the different representations of the same entity may differ slightly, due to various causes, such as typos, omissions, different styles, different word ordering, etc.

Private set intersection (PSI) allows one or more parties to compute the intersection of data without exposing the non-intersecting data to another party. In other words, PSI allows to test whether the parties share a common datapoint (such as a location, ID, etc.). Locality-sensitive hashing (LSH) is an algorithmic technique that hashes similar input items into the same “buckets” with high probability. Since similar items end up in the same buckets, this technique can be used for data clustering and nearest neighbor search.

### SUMMARY

According to one embodiment of the present invention, a computer-implemented method for privately determining data intersection is disclosed. The computer-implemented method includes performing private set intersection between two record sets to determine identical intersecting records corresponding to a particular record field. The computer-implemented method further includes removing any identical intersecting records from each record set to form two record subsets. The computer-implemented method further includes separately computing locality sensitive hash values for each of the two record subsets, wherein the locality sensitive hash values are computed for records corresponding to the particular record field. The computer-implemented method further includes jointly performing private set intersection between the locality sensitive hash values separately computed for each of the two record subsets. The computer-implemented method further includes determining that an intersecting pair of records between the two record subsets are a match based, at least in part, on a similarity score associated with the intersecting pair of records being above a predetermined threshold.

According to another embodiment of the present invention, a computer program product for privately determining data intersection is disclosed. The computer program product includes one or more computer readable storage media and program instructions stored on the one or more computer readable storage media. The program instructions include instructions to perform private set intersection between two record sets to determine identical intersecting records corresponding to a particular record field. The program instructions further include instructions to remove any identical intersecting records from each record set to form two record subsets. The program instructions further include instructions to separately compute locality sensitive hash values for each of the two record subsets, wherein the locality sensitive hash values are computed for records corresponding to the particular record field. The program instructions further include instructions to jointly perform private set intersection between the locality sensitive hash values separately computed for each of the two record subsets. The program instructions further include instructions to determine that an intersecting pair of records between the two record subsets are a match based, at least in part, on a similarity score associated with the intersecting pair of records being above a predetermined threshold.

According to another embodiment of the present invention, a computer system for privately determining data intersection is disclosed. The computer system includes one or more computer processors, one or more computer readable storage media, and computer program instructions, the computer program instructions being stored on the one or more computer readable storage media for execution by the one or more computer processors. The program instructions include instructions to perform private set intersection between two record sets to determine identical intersecting records corresponding to a particular record field. The program instructions further include instructions to remove any identical intersecting records from each record set to form two record subsets. The program instructions further include instructions to separately compute locality sensitive hash values for each of the two record subsets, wherein the locality sensitive hash values are computed for records corresponding to the particular record field. The program instructions further include instructions to jointly perform private set intersection between the locality sensitive hash values separately computed for each of the two record subsets. The program instructions further include instructions to determine that an intersecting pair of records between the two record subsets are a match based, at least in part, on a similarity score associated with the intersecting pair of records being above a predetermined threshold.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a network computing environment suitable for private data intersection program 101, generally designated 100, in accordance with at least one embodiment of the present invention.

FIG. 2 is a flow chart diagram depicting operational steps for determining intersecting data, generally designated 200, in accordance with at least one embodiment of the present invention.

FIG. 3 is a set of tables depicting sets of hash values generated for sets of shingles corresponding to respective data strings, sets of signatures associated with the sets of hash values, and depicting one or more buckets for one or more records, generally designated 300, in accordance with at least one embodiment of the present invention.

FIG. 4 is a block diagram depicting components of a computer, generally designated 600, suitable for executing private data intersection program 101, in accordance with at least one embodiment of the present invention.

FIG. 5 is a block diagram depicting a cloud computing environment 50 in accordance with at least one embodiment of the present invention.

FIG. 6 is block diagram depicting a set of functional abstraction model layers provided by cloud computing environment 50 depicted in FIG. 5 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of entity resolution, and more particularly to, private set intersection (PSI) and local sensitivity hashing (LSH) to preserve sensitive material while determining data intersection.

Recently, as the awareness for privacy increases and new regulations are enforced, there is a growing need for privacy preserving Entity-Resolution, and in particular, privacy preserving Record-Linkage (PPRL). For example, in the case where two companies need to learn their common clients or the number of such common clients, they typically cannot conduct such intersections openly, because this would reveal too much information to the other side or to eavesdroppers. The main challenge is due to the fact that the records do not match exactly due to the same client may differ slightly, due to various causes, such as typos, omissions, different styles, or different word ordering. Unfortunately, few practical protocols exist that securely perform such “fuzzy” record linkage without revealing some private data of the parties, and can do so within a reasonable time even for very large sets of data. The use of trusted third party may be a part of the solution, but is oftentimes undesirable, as it may introduce further security/privacy issues, and is thus avoided by the present invention.

Embodiments of the present invention recognize that commonly used hashing algorithms typically hash different inputs to different hash values such that collisions in the outputs are avoided or difficult to find. Even a small difference in the input can cause a dramatically different hash value. A Locality-Sensitive-Hashing (LSH) algorithm, on the other hand, deliberately hashes “similar” inputs to “similar” output hash value, where hashes are considered “similar” as described in further detail below.

Embodiments of the present invention provide for the ability of separate entities, without the use of a trusted third party, to find matching private data records between their respective databases, in a manner in which no private information is disclosed to either party, even when detected matches are not identical, but rather similar. In an embodiment, Private-Set Intersection (PSI) is not applied to the record fields of a dataset directly, but rather is applied to a Local-Sensitive-Hash (i.e., a hash that returns the same value for “similar” inputs) of the record fields calculated separately by each entity before performing PSI. Thus, the resulting intersection is those records between parties that have a matching LSH, and are thus considered to have a high probability of being similar. Each LSH is composed of multiple “band signatures” and two LSHs are considered matching when at they include at least one such band signature in common. The PSI is then carried out on these band signatures of the LSHs in order to privately learn the matching LSHs and thus the matching records.

In an embodiment, a fast PSI over regular hashes of selected record fields (e.g., a non-sensitive local hash, such as SHA-256) from each entities dataset is performed and matching records are eliminated. This initial “pre-processing step” reduces the number of records that will need to be considered in the later, more costly processing steps. PSI is then run over the LSHs (specifically, over their band signatures), which cleanly separates those record pairs that are very similar (e.g., having a similarity score above a predetermined threshold) from those record pairs that are not very similar (e.g., having a similarity below a predetermined threshold).

In an embodiment, a LSH includes b bands, where each of these b bands includes r min-hash signatures. In an embodiment, two records (or strings) are considered “similar” or “matching” if their two corresponding LSH's share a band—i.e., all the r min-hash signatures in some band from LSH1 of Record 1 are the same as the r min-hash signatures of some band from LSH2 of Record 2. Embodiments of the present invention determine if two records have a shared band in their LSH in a privacy-preserving manner using PSI. We also propose to optimize the accuracy and performance of our method by searching for the best b and r parameters using conventional optimization methods.

Embodiments of the present invention considers one record entry as matching another record entry when the LSHs of the two record entries share at least one of their b signatures, in which case the probability that they are an actual match is at least P, as set up by the optimization process. However, if more signatures match, the probability there is an exact match is in fact higher. The “score” of the match can relate to the number of shared signatures.

In other embodiments, the Jaccard similarity index which serves as the similarity score can be computed directly in a privacy-preserving manner by running the basic PSI protocol for the sets of shingles (i.e., overlapping substrings of fixed length of the concatenated fields of the compared records) of every candidate pairs. In an embodiment, if a score is to be produced for the pair RA of Dataset A of Party A and RB of Dataset B of Party B, then Party A and Party B run the PSI protocol to privately compute the Jaccard index, i.e. the number of shared shingles divided by the total number of shingles−|{shingles of RA}×{shingles of RB}|/|{shingles of RA} U {shingles of RB}|. Since just the size of these sets are needed here, one may use the embodiments of the present invention that only compute the size of the intersection |{shingles of RA}×{shingles of RB}| without revealing the shared shingles themselves. The size of the union |{shingles of RA} U {shingles of RB}| is the sum of the number of shingles of RA and RB (known to both parties performing the PSI) minus this size of the intersection.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

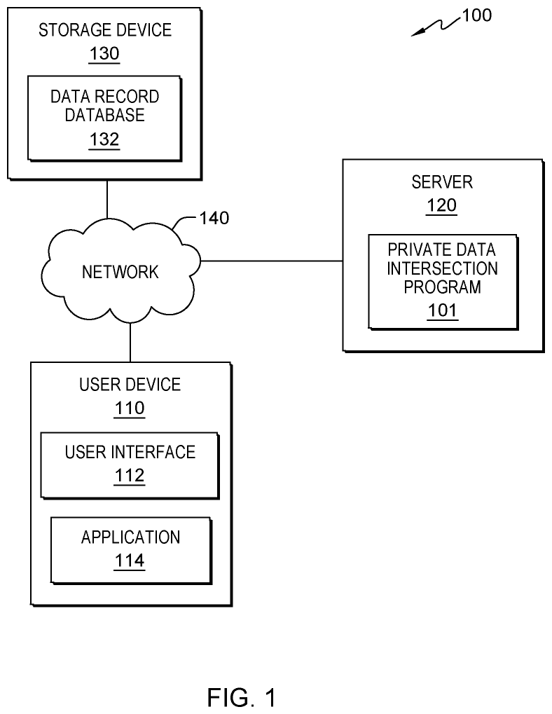

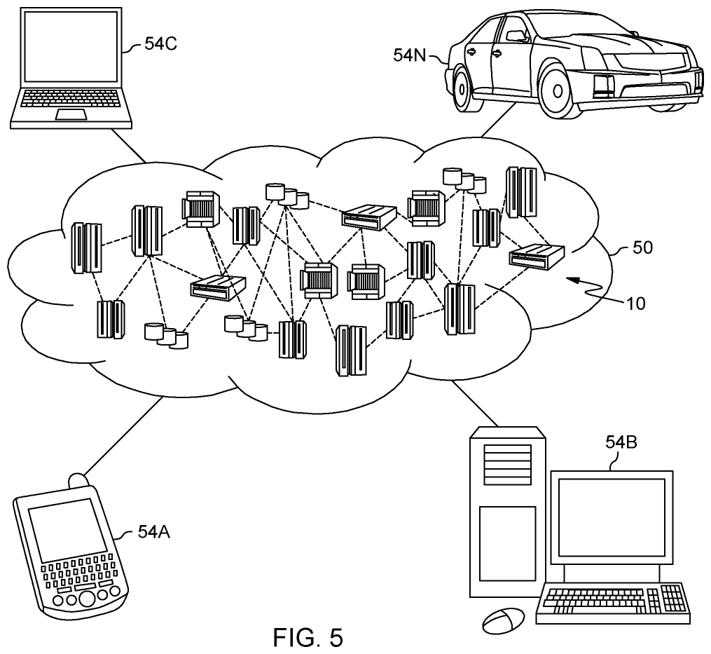

The present invention will now be described in detail with reference to the Figures. FIG. 1 is a functional block diagram of a network computing environment suitable for private data intersection program 101, generally designated 100, in accordance with at least one embodiment of the present invention. In an embodiment, network computing environment 100 may be provided by cloud computing environment 50, as depicted and described with reference to FIG. 5, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

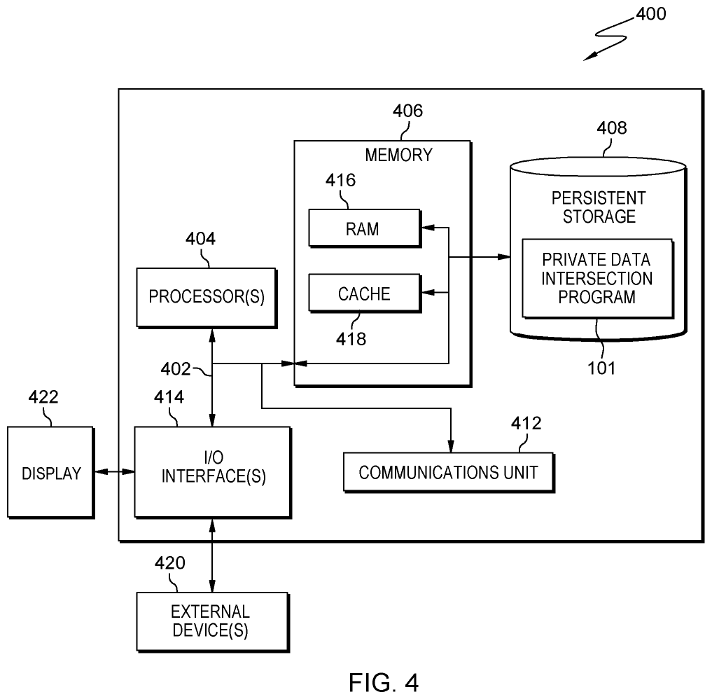

Network computing environment 100 includes user device 110, server 120, and storage device 130 interconnected over network 140. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130 and other devices (not depicted) via a network, such as network 140. User device 110 can include internal and external hardware components, as depicted and described in further detail with respect to FIG. 4. In an embodiment, there are one or more user device 110 interconnected over network 140.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API). In an embodiment, user interface 112 displays one or more records or intersecting matches between one or more records.

Application 114 can be representative of one or more applications (e.g., an application suite) that operate on user device 110. In an embodiment, application 114 is representative of one or more applications (e.g., record applications and database applications) located on user device 110. In various example embodiments, application 114 can be an application that a user of user device 110 utilizes to securely find matching records between multiple, individually owned private datasets without disclosing any private information between the parties. In an embodiment, application 114 can be a client-side application associated with a server-side application running on server 120 (e.g., a client-side application associated with private data intersection program 101). In an embodiment, application 114 can operate to perform processing steps of private data intersection program 101 (i.e., application 114 can be representative of private data intersection program 101 operating on user device 110).

Server 120 is configured to provide resources to various computing devices, such as user device 110. For example, server 120 may host various resources, such as private data intersection program 101 that are accessed and utilized by a plurality of devices. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g., database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, and other computing devices (not shown) within network computing environment 100 via a network, such as network 140.

In an embodiment, there are two or more servers connected via network 140. In an embodiment, the PSI protocol is carried out by the two interacting parties, each with its own separate server, storage device, and access to private data intersection program 101. For example, intersecting party Alice has sever A and storage device A and intersecting party Bob has server B and storage device B, all interconnected over network 140.

Server 120 may include components as depicted and described in detail with respect to cloud computing node 10, as described in reference to FIG. 5, in accordance with at least one embodiment of the present invention. Server 120 may include components, as depicted and described in detail with respect to computing device 400 of FIG. 4, in accordance with at least one embodiment of the present invention.

In an embodiment, server 120 includes private data intersection program 101. In an embodiment, private data intersection program 101 may be configured to access various data sources, such as data record database 132 that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, private data intersection program 101 enables the authorized and secure processing of personal data. In an embodiment, private data intersection program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, private data intersection program 101 provides information regarding personal data and the nature (e.g., type, scope, purpose, duration, etc.) of the processing. In an embodiment, private data intersection program 101 provides a user with copies of stored personal data. In an embodiment, private data intersection program 101 allows for the correction or completion of incorrect or incomplete personal data. In an embodiment, private data intersection program 101 allows for the immediate deletion of personal data.

In various embodiments, storage device 130 is a secure data repository for persistently storing data record database 132 utilized by various applications and user devices of a user, such as user device 110. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

In an embodiment, storage device 130 includes data record database 132. In an embodiment, data record database 132 stores information relating to one or more data records or data sets. In an embodiment, data record database 132 stores information associated with intersecting data records (i.e., two or more data records that have a similarity score above a predetermined threshold) between data sets. For example, if private data intersection program 101 determines that Data Record A from Data Set 1 and Data Record C from Data Set 2 have a similarity score above a predetermined threshold, the similarly score associated with the two data records, and optionally the two records themselves, are stored in data record database 132. In an embodiment, data record database 132 stores the number of intersecting data records between data sets, and the intersecting data records themselves in data record database 132. In another example, if private data intersection program 101 determines that four data records from Data Set C intersect (i.e., have a similarity score above a predetermined) with four data records from Data Set D, private data intersection program 101 stores information in data record database associated with the number of intersecting records, and optionally the intersecting records themselves, between Data Set C and Data Set D in data record database 132.

In an embodiment, two more storage device are connected over network 140. In an embodiment, two matching records belong to separate parties and are stored in two separate record databases. For example, even if party A learns that party B's database has a matching record, then party A doesn't get to see that matching record of B. Party A only learns which of its own records have matches in B's database. In some embodiments, Party A is also able to determine the similarity score of the matching record.

In an embodiment, private data intersection program 101 performs preprocessing on each data set. Preprocessing is the manipulation or dropping of data before it is used in order to ensure or enhance performance. Data preprocessing may be divided into four stages: data cleaning, data integration, data reduction, and data transformation. Data cleaning refers to techniques to ‘clean’ data by removing outliers, replacing missing values, smoothing noisy data, and correcting inconsistent data. Data integration removes redundant or inconsistent data. Data reduction includes condensing the data set that is smaller in volume, while maintaining the integrity of the original data set. Data transformation includes transforming the data into a form appropriate for data modeling.

In an embodiment, preprocessing includes joining fields. For example, only relatively unique fields are kept, while ordinary fields that are found in many records are removed. In an embodiment, a canonicalization process is performed on the data sets to convert the data sets into a standard, common form. For example, converting data to lower-case, removing non-alphanumeric characters and superfluous white spaces, and other canonicalization techniques.

In an embodiment, preprocessing includes determining cyclic shingles for each data set. Shingles are substrings of fixed length extracted from the concatenated fields of the record. Cyclic shingles start near the end of the concatenated fields and cycle back to the beginning. For example, if the concatenated fields are the string “John Doe Sunset Street 7034 Los Angeles”, then “eet 70” is a 6-character shingle, and “elesJo” is a 6-character cyclic shingle. The computation of a shingle set can be performed for example by extracting the k-shingles from the data string, after concatenating the first k−1 letters of the string to its end, where k is the desired shingle size. Then, the extraction of the shingles is done by taking every consecutive k letters in the new string. This gives a similar amount of weight for each letter in the original string. For example, without using this method, the first and last letters of the string may only appear in one shingle. Using this method, every letter appears in k shingles. In an embodiment, the text string is broken into a set of overlapping substrings of size k called shingles, i.e., every k consecutive characters in the string is an element in the set. In an embodiment, the similarity of two strings is measured in terms of shared shingles. In an embodiment, the “Jaccard similarity” of two strings is the size of the intersection divided by the size of the union of their respective sets of shingles.

In an embodiment, private data intersection program 101 performs private set intersection on the one or more record sets. In an embodiment, private set intersection determines the exact matches between the one or more record sets. In an embodiment, private data intersection program 101 performs a fast PSI of selected record fields (i.e., non-sensitive local hash) from each respective data set and matching pairs with identical fields (or identical subsets of fields) are eliminated. For example, let it be assumed that records A and B both include the social-security-number field value “123456789”. Here, private data intersection program 101 performs PSI on the SSN field and determines there is an identical match for record A and record B. Accordingly, private data intersection program 101 eliminates record entry A from database A and record entry B from database B in order to reduce the number of record entries compared during further processing steps. In an embodiment, private data intersection program 101 computes a locality sensitive hash for those records remaining in each respective data set after performing PSI. In other words, private data intersection program 101 computes a LSH for the remaining data entries not removed after performing PSI. In an embodiment, private data intersection program 101 computes a separate locality sensitive hash for each record of each respective data set.

In an embodiment, Private-Set Intersection (PSI) is not applied to the record fields of a dataset directly, but rather is applied to a Local-Sensitive-Hash (i.e., a hash that returns the same value for “similar” inputs) of the record fields calculated separately by each entity before performing PSI. Thus, the resulting intersection is those records between parties that share a LSH, and are thus considered to have a high probability of being similar (e.g., having a similarity score above a predetermined threshold).

In an embodiment, private data intersection program 101 converts a text string (e.g., a name, an address, or a phone number) into a set of shingles. In an embodiment, each entry is hashed as a LSH which is a tuple of b signatures, and two LSHs are considered “similar” with a high probability (e.g., having a similarity score above a predetermined threshold) if at least one of the b signatures in the two tuples is the same. In an embodiment, each of the b signatures are computed.

In an embodiment, private data intersection 101 applies a plurality of different hashing functions to each record of a data set to generate a plurality of min-hash values for each record of a data set. For example, private data intersection 101 applies one-hundred different hashing functions to Record A of Data Set 1, which thereby generates one-hundred different min-hash values for Record A. Private data intersection 101 may then apply the same one-hundred different hashing functions to Record B, Record C . . . Record N of Data Set 1. The application of a hash function to compute the min-hash value of a record involves evaluating the hash function over all the shingles of the record and returning the minimal result. This type of hash is called a MIN-HASH.

In an embodiment, private data intersection program 101 groups the min-hash values for the record into b “bands” of r min-hashes in each band. For example, if 100 min-hashes are computed for the record, then they may be grouped into b=20 bands of r=5 min-hashes per band. In an embodiment, private data intersection program 101 takes these r min-hash values of a band and hashes them into a respective band signature. In an embodiment, private data intersection program 101 repeats this process b times to produce b signatures. The resulting tuple of b signatures is the LSH of the record. Two records are considered “similar” if they share at least one of their b signatures.

In an embodiment, a hash based signature is a signature computer using a hashing function. In an embodiment, the predetermined number of min-hash signatures to be computed for a locality sensitive hash value and the predetermined number of signature bands created is adjusted based on particular accuracy and performance requirements.

If at least one of the b signatures is shared between the two LSHs then a possible match is declared. The probability that this is indeed a true match increases if there are more than just the one required shared band—the more shared bands out of the total b bands—the higher the probability that the match estimate is correct. In addition, if b is configured to be smaller, then the fact that there is even just a single shared band is more significant. Thus, having a single shared band when b is set to be small indicates a higher probability that the match is true than if the single shared band is one of many bands. For example, 1 shared band out of b=4 bands indicates a much higher probability of similarity than one shared band out of b=400 bands. Also, two shared bands out of b=4 bands indicates a higher probability of similarity than just one shared band out of b=4 bands.

In an embodiment, private data intersection program 101 performs PSI over the respective sets of band signatures of the LSH values. A pair of records with no matching LSH are non-identical and probably also or non-similar.

In an embodiment, private data intersection program 101 determines a Jaccard similarity to determine if there is a match between at least two data records. The Jaccard index, also known as the Jaccard similarity coefficient, is a statistic used for gauging the similarity and diversity of sample sets. The Jaccard index can be determined by:

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} .$$

J is the Jaccard distance. In an embodiment, A is the set of shingles of record A from first data set, and B is the set of shingles of record B from the second data set. In an embodiment, there is a probability that a pair A and B with a small Jaccard (A,B) would still be matched by having a shared band signature (thus resulting in a possible false positive). In an embodiment, the Jaccard threshold (JT) is selected based on user input. In an embodiment, match control is when a user selects a Jaccard threshold (JT). For example, the user determines a Jaccard threshold (JT) and a probability P, a “separation” S and small epsilon. This creates the following: a pair A,B with Jaccard(A,B)>JT will be matched with probability>P, and a pair A,B with Jaccard(A,B)<JT-S will be matched with probability<epsilon.

For example, the probability that two strings A and B will be paired as a result of the above procedure is 1−(1−Jaccard(A,B)\hat{ }r)\hat{ }b. Match control can be achieved via a correct setting of r and b. Fine tuning r and b can increase the accuracy of the scheme in detecting matches that are similar beyond some desired Jaccard threshold with some desired probability.

However, in embodiments of the present invention, increasing r comes with a different cost than increasing b. Typically, increasing r leads to more hash computations over plaintexts and is relatively cheap. However, increasing b implies more costly cryptographic computations (e.g., power raising when using Diffie-Hellman based PSI). Picking different parameters may also lead to privacy tradeoffs (since the pairs that are considered “similar” according to the parameters are those that will be divulged to the users). Therefore private, data intersection program 101 solves the optimization problem of finding b and r that meet the security and match-control requirements while minimizing b for the sake of performance. This can either be done by empirical search, or by coming up with the formula for b and r analytically.

In an embodiment, the task is to compute the cardinality of the intersection and not the intersection itself. For example, for the purpose of pricing advertisements on the web. A user could count the size of the sets that result from the above described process, but this would reveal to the two sides more information beyond the size of the intersection. However, when the PSI protocol uses similar interactions as in Diffie-Hellman based PSI, then a user can randomly reorder the records in the list they got from the other user and also randomly reorder the bands in each of the LSHs of that list, before returning it to the other with his own “power-raising”. Both users will perform this process to the records they receive from the other user. This reordering will hide from the users the identity of her/his matched records, and allow for counting the number of matched pairs without revealing any further information about them. In addition, one can easily combine this cardinality computation with the scoring scheme previously described.

In an embodiment, private data intersection program 101 is used for two or more parties or users. Each party or user generates hashes from its own records. Then, each of the N collections of hashes is passed between all the members, and each member applies its secret key to each of the hashes. Identifiers of members who already applied their secret key to a collection is attached to it. Once a collection is signed by N members it is distributed by the last signing member to the other members, so that each member has N collections, each signed by N members. Finally, each member searches for the band signatures that occur in all the N collections, to deduce the matching LSHs and hence the similar records.

In an embodiment, the user configures the rules by which two records are considered as candidates. For each field in the database, records can be considered as matching if the field (e.g., an SSN field) contains the exact same value for both. Alternately, records can be considered as candidates if the field (e.g., a home address field) contains a similar value. The rules can be ordered in the order in which they are to be applied. Rules that are fast to apply (e.g., just PSI with identical field checks) are applied first, so that the resulting candidates are not considered during the application of the latter more costly rules (that may require many band computations for similarity checks).

In an embodiment, private data intersection program 101 first applies a screen candidate with the exact value in the fields marked to be screened by that rule (e.g., an SSN field). In an embodiment, private data intersection program 101 applies one or more hash algorithms on the field or group of fields to produce the min-hashes and the band signatures and uses PSI based on Diffie-Hellman to find records of the other party with the same band-signature values. Diffie-Hellman key exchange is a method of securely exchanging cryptographic keys over a public channel. After identifying candidates records by the first rule, private data intersection program 101 removes them from the database and uses similarity based private set intersection to identify candidate records by the second rule. In an embodiment, Diffie-Hellman is used to perform PSI, however, it should be appreciated any known methods of PSI may be performed.

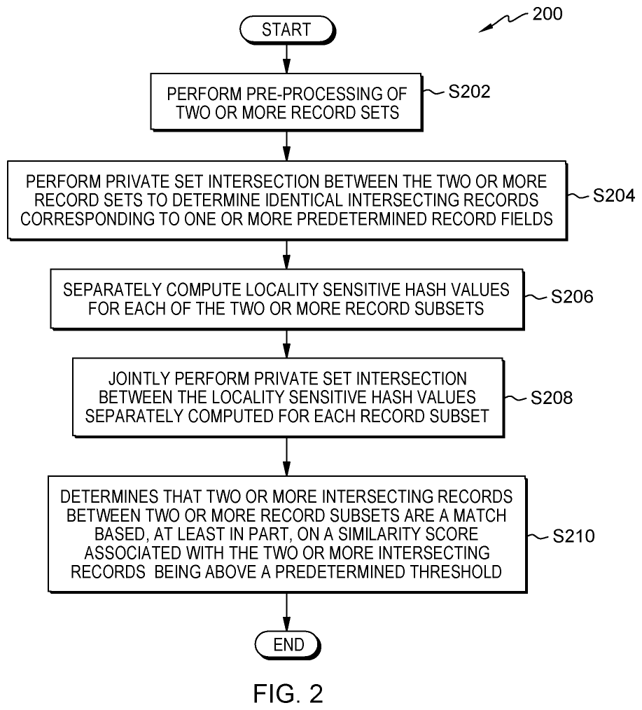

FIG. 2 is a flow chart diagram depicting operational steps for determining intersecting data, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, data intersection program 101 performs pre-processing of two or more record sets. In an embodiment, each record set of the two or more record sets are accessible by a respective authenticated user. For example, a first record set is only accessible by Alice and a second record set is only accessible by Bob. In an embodiment, each record of a record set includes one or more private pieces of data, such as a phone number, address, social security number, credit card number, etc. In an embodiment, pre-processing includes converting each record into one or more data strings.

At step S204, data intersection program 101 performs private set intersection between the two or more record sets to determine identical intersecting records corresponding to one or more predetermined record fields. In an embodiment, private set intersection is performed to determine an exact match for a particular data string associated with a record in each of the two or more record sets. In an embodiment, private data intersection program 101 performs private set intersection over regular hashes and report matches for data string pairs between the two or more records sets corresponding to a particular record field(s). In an embodiment, performing private set intersection between the two or more record sets further includes removing any identical intersecting records from each record set to form a plurality of record subsets. For example, if Record Set 1 and Record Set 2 each originally have a total of 10 records in each set and it is determined that two intersecting record pairs exist between Record Set 1 and Record Set 2 (e.g., because each pair shared an identical SSN), then the two matched record pairs are removed, resulting in Record Subset 1 and Record Subset 2 each having only 8 total records.

At step S206, data intersection program 101 separately computes locality sensitive hash values for each of the two or more record subsets. In an embodiment, the locality sensitive hash values are computed for records corresponding to the one or more predetermined record fields. For example, locality sensitive hashing is performed (by Alice/Party A) on records from Record Set 1 for records fields corresponding to the “home address” to which only Alice is authorized access and is again separately performed (by Bob/Party B) on records from Record Set 2 for the same home address fields to which only Bob is authorized access.

At step S208, data intersection program 101 jointly performs private set intersection between the locality sensitive hash values separately computed for each record subset.

At decision step S210, data intersection program 101 determines that two or more intersecting records between two or more record subsets are a match based, at least in part, on a similarity score associated with the two or more intersecting records being with some predetermined probability above a predetermined threshold.

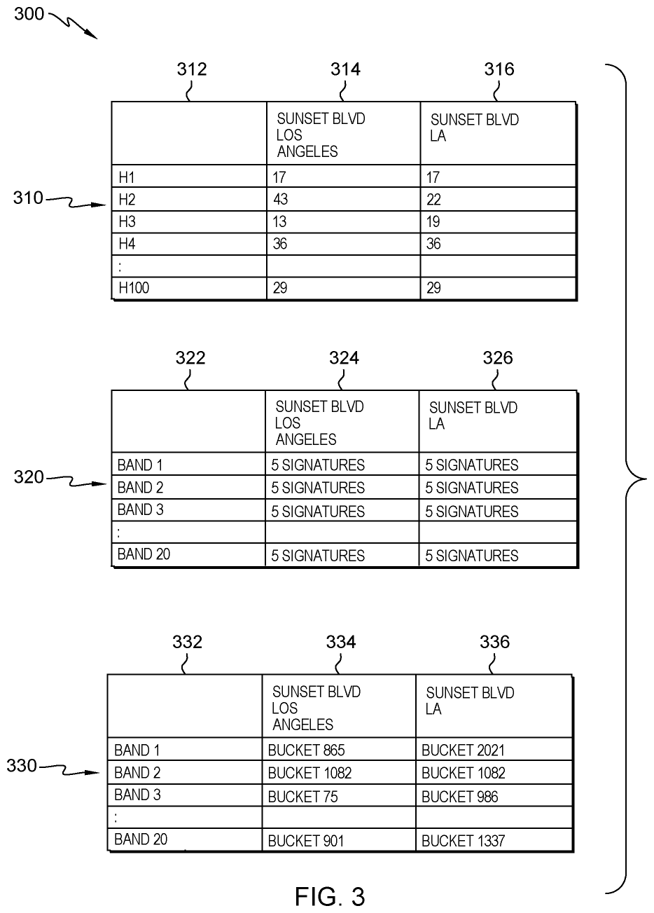

FIG. 3 depicts various table data generated for determining one or more intersecting pairs of data between two private data sets generally designated 300, in accordance with at least one embodiment of the present invention. Table 310 depicts a set of min-hash values generated for sets of shingles corresponding to respective data strings (shown in the column headers). In an embodiment, data intersection program 101 determines a string and converts into a set of shingles. In FIG. 3, an address is converted into a set of shingles. The hash functions are depicted in column 312. Min-Hash values for the string A “SUNSET BLVD LOS ANGELES” taken from a record from data set A from company A are depicted in column 314 and hash values for the string B “SUNSET BLVD LA” taken from a record from data set B from company B are depicted in column 316. As depicted in FIG. 3, data intersection program 101 uses hash function H1 to compute H1 (shingle) on all the shingles of string A and save the minimum result (17 in this case as shown). This MINHASH result is H1's signature for the string A. In this example, this is repeated for 100 different hashes to receive 100 signatures per string.

In an embodiment, data intersection program 101 splits the 100 signatures into 20 bands of 5 signatures each. Table 320 is a chart diagram depicting how the 100 min-hashes are grouped into 20 bands of 5 min-hash signatures for the record of string A and for the record of string B. Chart 320 depicts band column 322, the min-hash signatures for string A of record A from data set A from company A in column 324 and the min-hash signatures for string B of record B from data set B from company B in column 326.

Table 330 is a chart diagram depicting the band signatures that form the LSH for the compared pair of records. Table 330 depicts band column 332, the band signature for string A of record A from data set A from company A in column 334 and the band signature for string B of record B from data set B from company B in column 336. In an embodiment, data intersection program 101 uses a separate hash to hash the 5 signatures from table 320 column 324 into different hash “buckets”. Meaning, every original address string ends up in 20 different buckets (i.e. one bucket per band). Strings that end up in the same bucket in any of their 20 buckets are considered similar, and thus cause their source records to be matched by the PPRL process. As depicted in table 330, the strings in Band 2 are in the same bucket and are candidate matched entities.

FIG. 4 is a block diagram depicting components of a computing device, generally designated 400, suitable for private data intersection program 101 in accordance with at least one embodiment of the invention. Computing device 400 includes one or more processor(s) 404 (including one or more computer processors), communications fabric 402, memory 406 including, RAM 416 and cache 418, persistent storage 408, which further includes private data intersection program 101, communications unit 412, I/O interface(s) 414, display 422, and external device(s) 420. It should be appreciated that FIG. 4 provides only an illustration of one embodiment and does not imply any limitations with regard to the environments in which different embodiments may be implemented. Many modifications to the depicted environment may be made.

As depicted, computing device 400 operates over communications fabric 402, which provides communications between computer processor(s) 404, memory 406, persistent storage 408, communications unit 412, and input/output (I/O) interface(s) 414. Communications fabric 402 can be implemented with any architecture suitable for passing data or control information between processor(s) 404 (e.g., microprocessors, communications processors, and network processors), memory 406, external device(s) 420, and any other hardware components within a system. For example, communications fabric 402 can be implemented with one or more buses.

Memory 406 and persistent storage 408 are computer readable storage media. In the depicted embodiment, memory 406 includes random-access memory (RAM) 416 and cache 418. In general, memory 406 can include any suitable volatile or non-volatile computer readable storage media.

Program instructions for private data intersection program 101 can be stored in persistent storage 408, or more generally, any computer readable storage media, for execution by one or more of the respective computer processor(s) 404 via one or more memories of memory 406. Persistent storage 408 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 can include one or more network interface cards. Communications unit 412 may provide communications through the use of either or both physical and wireless communications links. In the context of some embodiments of the present invention, the source of the various input data may be physically remote to computing device 400 such that the input data may be received, and the output similarly transmitted via communications unit 412.

I/O interface(s) 414 allows for input and output of data with other devices that may operate in conjunction with computing device 400. For example, I/O interface(s) 414 may provide a connection to external device(s) 420, which may be as a keyboard, keypad, a touch screen, or other suitable input devices. External device(s) 420 can also include portable computer readable storage media, for example thumb drives, portable optical or magnetic disks, and memory cards. Software and data used to practice embodiments of the present invention can be stored on such portable computer readable storage media and may be loaded onto persistent storage 408 via I/O interface(s) 414. I/O interface(s) 414 also can similarly connect to display 422. Display 422 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

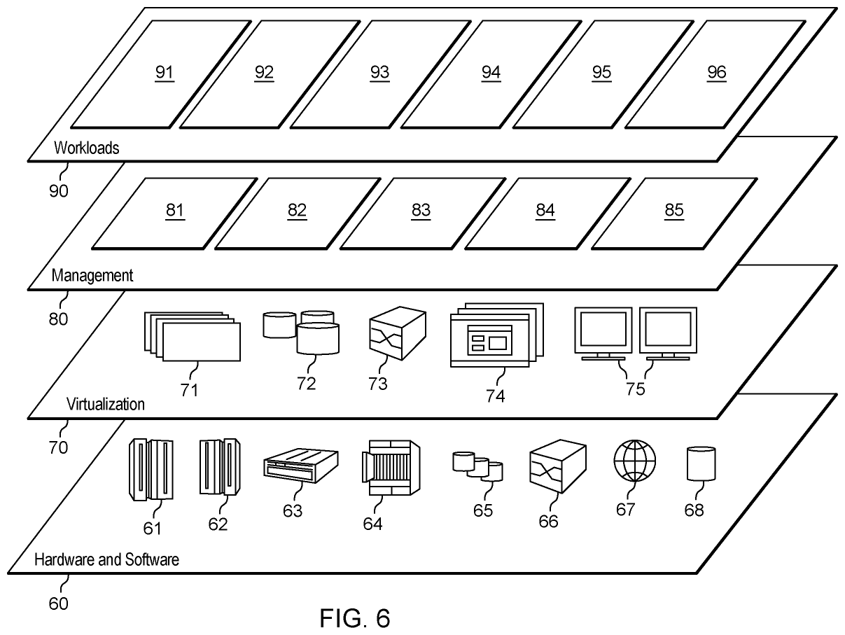

FIG. 6 is block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and private data intersection 96.

What is claimed is:

1. A computer-implemented method for privately determining data intersection, the computer-implemented method comprising:
performing private set intersection between two record sets to determine identical intersecting records corresponding to a particular record field;
removing any identical intersecting records from each record set to form two record subsets;
separately computing locality sensitive hash values for each of the two record subsets, wherein the locality sensitive hash values are computed for records corresponding to the particular record field;
jointly performing private set intersection between the locality sensitive hash values separately computed for each of the two record subsets; and
determining that an intersecting pair of records between the two record subsets are a match based, at least in part, on a similarity score associated with the intersecting pair of records being above a predetermined threshold.

2. The computer-implemented method of claim 1, wherein separately computing locality sensitive hash values for each of the two record subsets further comprises:
computing a predetermined number of min-hash signatures for each locality sensitive hash value; and
dividing the min-hash signatures computed for each locality sensitive into a predetermined number of signature bands.

3. The computer-implemented method of claim 2, determining that an intersecting pair of records between the two record subsets are a match is further based, at least in part on, each of the intersecting pair or records sharing a same signature band.

4. The computer-implemented method of claim 3, wherein a probability of determining that the intersecting pair of records between the two record subsets are a match and an amount of time for finding all intersecting pairs of records between the two record subsets is dependent on a total number of min-hash signatures computed for a locality sensitive hash value and a total number of signature bands created.

5. The computer-implemented method of claim 3, wherein the predetermined number of min-hash signatures to be computed for a locality sensitive hash value and the predetermined number of signature bands created is adjusted based on particular accuracy and performance requirements.

6. The computer-implemented method of claim 1, wherein separately computing locality sensitive hash values for each of the two record subsets further includes:
generating a set of overlapping substrings for each record corresponding to the particular record field; and
for each hash function in a set of hash functions:
generating a hash value for each overlapping substring in the set of overlapping substrings for each record corresponding to the particular record field; and
determining a minimum value of any hash value generated amongst the set of overlapping substrings of a record.

7. The computer-implemented method of claim 6, further comprising:
for each minimum value generated from each hash function in the set of hash functions, computing a hash-based signature.

8. The computer-implemented method of claim 7, wherein determining an intersecting pair of records between the two record subsets is further based on:
determining that the intersecting pair of records share at least one hash-based signature.

9. The computer-implemented method of claim 1, wherein determining that an intersecting pair of records between the two record subsets are a match is further based, at least in part, on a Jaccard similarity being above a predetermined threshold.

10. The computer-implemented method of claim 9, further comprising:
separately computing the Jaccard similarity for each of the two record subsets, wherein the Jaccard similarity is a number of shared substrings corresponding to the particular record field divided by a total number of overlapping substrings of each record subset.

11. The computer-implemented method of claim 1, wherein jointly performing private set intersection between the locality sensitive hash values separately computed for each of the two record subsets further include determining one or more matching pairs of LSH values based on the jointly performed private set intersection.

12. The computer-implemented method of claim 1, further comprising:
applying two or more different hashing functions to the two record subsets to generate a plurality of hash values for the two record subsets.

13. The computer-implemented method of claim 1, wherein the similarity score is based, at least in part, on determining the number of shared hash-based signatures.

14. A computer program product for privately determining data intersection, the computer program product comprising one or more computer readable storage media and program instructions stored on the one or more computer readable storage media, the program instructions including instructions to:
perform private set intersection between two record sets to determine identical intersecting records corresponding to a particular record field;
remove any identical intersecting records from each record set to form two record subsets;
separately compute locality sensitive hash values for each of the two record subsets, wherein the locality sensitive hash values are computed for records corresponding to the particular record field;
jointly perform private set intersection between the locality sensitive hash values separately computed for each of the two record subsets; and
determine that an intersecting pair of records between the two record subsets are a match based, at least in part, on a similarity score associated with the intersecting pair of records being above a predetermined threshold.

15. The computer program product of claim 14, wherein one record subset matches another record subset if each record subset share at least one b signatures and wherein the probability of the match increases if the number of shared band signatures among the b band signature increases.

16. The computer program product of claim 14, wherein the instructions to separately compute locality sensitive hash values for each of the two record subsets further includes instructions to:
generate a set of overlapping substrings for each record corresponding to the particular record field; and
for each hash function in a set of hash functions:
generate a hash value for each overlapping substring in the set of overlapping substrings for each record corresponding to the particular record field; and
determine a minimum value of any hash value generated amongst the set of overlapping substrings of a record.

17. The computer program product of claim 16, further comprising instructions:
for each minimum value generated from each hash function in the set of hash functions, computing a hash-based signature.

18. The computer program product of claim 17, wherein the instructions to determine an intersecting pair of records between the two record subsets is further based on instructions to:
determine that the intersecting pair of records share at least one hash-based signature.

19. The computer program product of claim 14, wherein the instructions to determine that an intersecting pair of records between the two record subsets are a match is further based, at least in part, on a Jaccard similarity being above a predetermined threshold.

20. A computer system for privately determining data intersection, comprising:
one or more computer processors;
one or more computer readable storage media;
computer program instructions;
the computer program instructions being stored on the one or more computer readable storage media for execution by the one or more computer processors; and
the computer program instructions including instructions to:
perform private set intersection between two record sets to determine identical intersecting records corresponding to a particular record field;
remove any identical intersecting records from each record set to form two record subsets;
separately compute locality sensitive hash values for each of the two record subsets, wherein the locality sensitive hash values are computed for records corresponding to the particular record field;
jointly perform private set intersection between the locality sensitive hash values separately computed for each of the two record subsets; and
determine that an intersecting pair of records between the two record subsets are a match based, at least in part, on a similarity score associated with the intersecting pair of records being above a predetermined threshold.
